(19) United States
(12) Patent Application Publication
(10) Pub. No.: US 2011/0058767 A1
(43) Pub. Date: Mar. 10, 2011

(54) Reinforced Sensor With Optical Fiber Woven Into Fabric

(75) Inventors: Hisayoshi Ishibashi, Tokyo (JP); Hirokazu Suzuki, Tokyo (JP); Kiyoshi Oka, Ibaraki (JP); Akihiko Nishimura, Kyoto (JP); Kazuyuki Tsukimori, Fukui (JP); Sumiyuki Matsubara, Tokyo (JP); Kazumasa Kosugi, Tokyo (JP)

(73) Assignees: KUMAGAI GUMI CO., LTD., Kukui (JP); JAPAN ATOMIC ENERGY AGENCY, Ibaraki (JP); FIBEX CO., LTD., Tokyo (JP)

(21) Appl. No.: 12/868,016

(22) Filed: Aug. 25, 2010

(30) Foreign Application Priority Data
Sep. 7, 2009 (JP) 2009-205983

(51) Int. Cl. G02B 6/00

(52) U.S. Cl. 385/12

(57) ABSTRACT

A reinforced sensor with an optical fiber woven into a fabric, comprising a fabric formed in a manner that a weft yarn is woven thereinto in a direction substantially perpendicular to a warp yarn, wherein an optical fiber is included in at least either one of fibers of the warp yarn and the weft yarn. The optical fiber may function as a FBG sensor.

### BACKGROUND OF THE INVENTION

1. Field of the Invention

The present invention relates to a sensor for measuring the strain and the like of a measuring object, and more particularly, to a reinforced sensor with an optical fiber woven into a fabric.

2. Description of the Related Art

Conventionally, there are known sensors of the type that uses an optical fiber to measure strain, vibration, temperature, and the like of measuring objects, such as structures and pipings. However, the optical fiber used in sensors of this type is formed of a fine glass fiber having a diameter of about 100 microns, and it is so delicate that sufficiently careful attention has to be paid to avoid damage to the optical fiber at the time of attachment to the measuring object.

As such, in recent years, there have been proposed, for example, a sensor in which the surface of the optical fiber is integrally protected with a protection film, such as a ultraviolet (UV) curable resin film or polyamide film, and a sensor in which the optical fiber is indirectly (non-integrally) protected with a protection tube formed of, for example, a stainless steel flexible tube, PEEK (Poly Ether Ether Ketone) resin, or PVDF (PolyVinylidene DiFluoride) (refer to Patent Documents 1 and 2 listed below, for example).

Patent Document 1: Japanese Unexamined Patent Application Publication No. 2001-296110

Patent Document 2: PCT Japanese Translation Patent Publication No. 2008-534982

### SUMMARY OF THE INVENTION

However, as in the case of the former related art described above, in the case of the sensor in which the surface of the optical fiber is integrally protected, the sensor is still thin and delicate. Hence, it is difficult to prevent the optical fiber from being, for example, broken or fractured at the time of attachment to a measuring object.

On the other hand, as in the case of the latter related art described above, in the case of the sensor in which the optical fiber is indirectly (non-integrally) protected with the protection tube, the protection tube is not integrated with the optical fiber. Hence, a problem is posed in that, even when the protection tube is attached to a measuring object, the strain or the like of the measuring object is not transmitted enough to the optical fiber, so that the accuracy of measurement cannot be improved.

The present invention is made to solve the problems described above, and an object of the invention is to provide a reinforced sensor with an optical fiber woven into a fabric that is capable of preventing the optical fiber from being, for example, broken or fractured at the time of attachment to a measuring object, and concurrently, that is capable of improving the accuracy of measurement.

In order to achieve the object described above, a reinforced sensor with an optical fiber woven into a fabric, according to the present invention, includes a fabric formed in a manner that a weft yarn is woven thereinto in a direction substantially perpendicular to a warp yarn, wherein an optical fiber is included in at least either one of fibers of the warp yarn and the weft yarn.

In the reinforced sensor with an optical fiber woven into a fabric, according to the present invention, it is preferable that the at least either one of fibers include a high strength fiber higher in tensile strength than the optical fiber.

Further, in the reinforced sensor with an optical fiber woven into a fabric, according to the present invention, it is preferable that the one of the fibers form a fiber bundle including the optical fiber.

Further, in the reinforced sensor with an optical fiber woven into a fabric, according to the present invention, the at least either one of the fibers may include a plurality of the optical fibers.

Further, in the reinforced sensor with an optical fiber woven into a fabric, according to the present invention, the optical fiber may function as a FBG (Fiber Bragg Grating) sensor.

Further, in the reinforced sensor with an optical fiber woven into a fabric, according to the present invention, it is preferable that a marking for identification of sensor sections of the optical fiber be provided.

Further, in the reinforced sensor with an optical fiber woven into a fabric, according to the present invention, it is preferable that a protection film be provided on the side of an outer face.

According to the present invention, various excellent effects can be obtained in that, for example, the optical fiber can be prevented from being, for example, broken or fractured at the time of attachment of the sensor to a measuring object, the reliability of the sensor can be improved, and concurrently, the accuracy of measurement can be improved.

### BRIEF DESCRIPTION OF THE DRAWINGS

FIG. 1 is a plan view showing a reinforced sensor with an optical fiber woven into a fabric in accordance with an embodiment of the present invention;

FIG. 2 is a plan view showing a fiber bundle of the reinforced sensor with an optical fiber woven into a fabric in accordance with the embodiment of the present invention; and

FIG. 3 is a plan view showing another example of a reinforced sensor with an optical fiber woven into a fabric in accordance with the embodiment of the present invention.

### DESCRIPTION OF THE PREFERRED EMBODIMENT

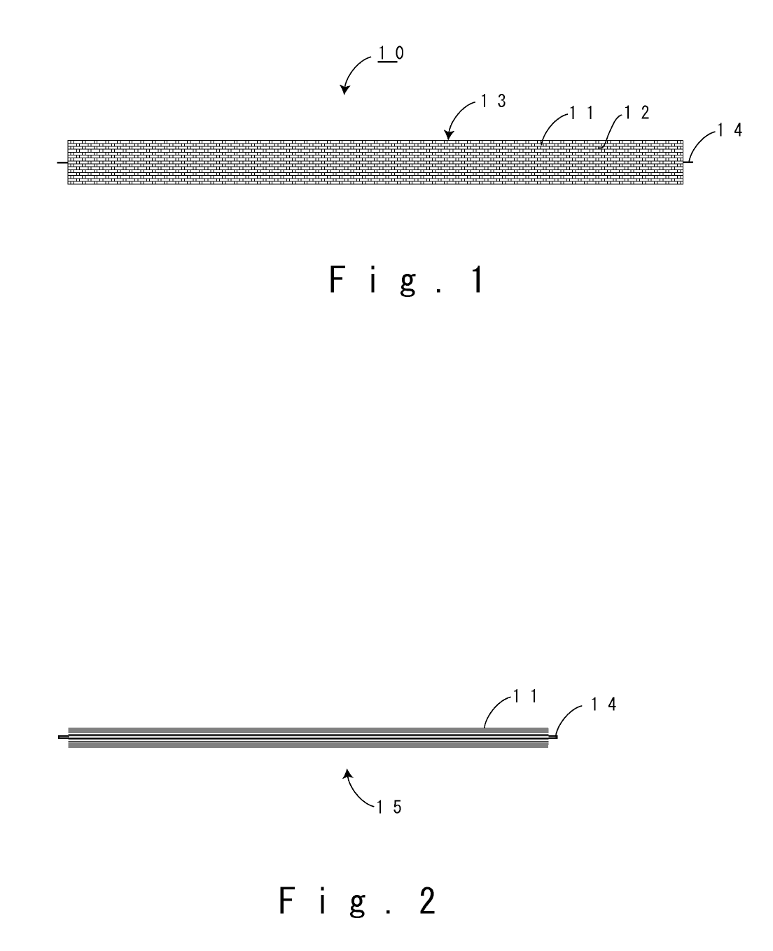

Referring to the drawings, an embodiment of the present invention will be described hereinbelow. FIG. 1 is a plan view showing a reinforced sensor with an optical fiber woven into a fabric in accordance with an embodiment of the present invention; and FIG. 2 is a plan view showing a fiber bundle of the sensor.

The sensor 10 of the present embodiment includes a fabric 13 formed in the manner that a weft yarn 12 is woven thereinto in a direction substantially perpendicular to a warp yarns 11. The fabric 13 has a shape as a strip having a width of, for example, 5 to 1000 mm, and the warp yarn 11 of the fabric 13 includes an optical fiber 14.

As explicitly shown in FIG. 2, the warp yarn 11 forms a fiber bundle 15. One fiber bundle 15 includes one optical fiber 14, and is formed from, for example, one optical fiber 14 and 99 glass fibers. For the warp yarn 11 and the weft yarn 12, any one of, for example, carbon, aramid, glass, and alumina fibers, and in addition, any one of synthetic fibers such as nylon, vinylon, and polyester can be used. However, it is preferable that a high strength fiber higher in tensile strength than the optical fiber 14 be used for protection of the optical fiber 14. Alternatively, combinations of different types of fibers can be used in such a manner that the materials of the warp yarn 11 and the weft yarn 12 are changed to be different from each other as in the case where, for example, the glass fiber is used for the warp yarn 11 and the carbon fiber is used for the weft yarn 12, or plural types of fibers are mixed for the warp yarn 11 and the weft yarn 12.

In the present embodiment, the optical fiber 14 functions as an FBG (Fiber Bragg Grating) sensor. The FBG sensor is a known sensor that has plural sensor sections (not shown) formed through irradiation of ultraviolet (UV) light onto the core of the optical fiber 14, in which changes in wavelength of light reflecting in the sensor sections are used to measure the strain, pressure, temperature, and the like of measuring objects.

When measuring the strain of a measuring object, such as a structure or piping, by using a sensor 10 having the above-described construction, first the sensor 10 in the state it is rolled as a scroll for example is carried in a site where the measuring object is located. Thereafter, the sensor sections of the optical fiber 14 are fixed to the measuring object with an adhesive, band, or the like, and is then used to measure the strain.

Thus, according to the sensor 10 of the above-described embodiment of the present invention, the optical fiber 14 is protected with the fiber, the fiber bundle 15, and the like. Hence, the operation of attachment of the sensor 10 to the measuring object is facilitated, and in addition, the optical fiber 14 can be prevented from being, for example, broken or fractured at the time of attachment of the sensor 10 to the measuring object.

In addition, since the sensor sections of the optical fiber 14 are fixed to the measuring object, the strain or the like securely transmits to the measuring object, thereby enabling the accuracy of measurement to be improved.

Further, since the sensor 10 can be carried in the rolled state, the carrying work can be simplified.

Further, the sensor 10 can easily be attached to the measuring object in the manner that the sensor 10 is extended by fusion splicing the ends of sensor optical fibers 14 together, therefore enabling the versatility to increase.

Further, when a high strength fiber, such as a carbon, aramid, glass, or alumina fiber, is used for the warp yarn 11 and the weft yarn 12 and is attached to the measuring object, the strain or the like can be measured, and also reinforcement of the measuring object can be implemented.

Further, the present invention is capable of performing measurement of displacements, vibrations, and the like factors of, for example, equipment and piping of fast reactor plants and the like installed under high temperature and high radiation, and a large variety of other types of measurement. They are, for example, the displacement measurement of, for example, floorboards and girders in bridges, crack measurement of concrete, displacement measurement of tunnel junctions, pressure measurement of rocks in tunnels, behavior measurement in dams, tension measurement of piles, and landslide measurement.

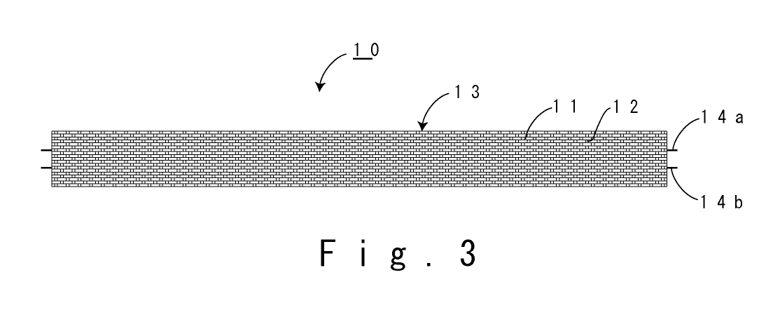

As shown in FIG. 3, the warp yarn 11 of the sensor 10 may include plural optical fibers 14a and 14b. In this case, for example, the optical fibers can be distinguishingly used in such a manner that the one optical fiber 14a is used for measurement of near points and the other optical fiber 14b is used for measurement of distal points. Alternatively, for example, the optical fiber can be used for measurement of a temperature change of a measuring object in such a manner that only the one optical fiber 14a is adhered to the measuring object while the other optical fiber 14b is not adhered thereto. Still alternatively, for example, the plural optical fibers 14a and 14b are used for the same measurement to improve the accuracy of measurement, thereby enabling the reliability of the sensor 10 to be improved. Yet alternatively, for example, the other optical fiber 14b is used as a spare, thereby enabling the responding capacity for failure events to be improved.

While, in the above-described embodiment, description has been made with reference to the case where the optical fiber 14 functions as the FBG sensor, it is only an exemplification, and the present invention is adaptable even to cases where the optical fiber 14 functions as sensors other than the FGB sensor. The other sensors include, for example, a so-called microbending sensor that detects a change in the amount of penetrated light to thereby measure the strain of a measuring object; a so-called Rayleigh scattering sensor that detects a change in the amount of reflected light to thereby measure the strain of a measuring object; and a sensor of the type that uses the optical fiber 14 to thereby measure, for example, the vibration, temperature, pressure, ultrasonic wave, neutron, and γ-ray amount of measuring objects.

Further, in the above-described embodiment, the optical fiber 14 is included only in the warp yarn 11. However, the optical fiber 14 may be included at least in either one of the fibers of the warp yarn 11 and the weft yarn 12 in such a manner that the optical fiber 14 is included in either the weft yarn 12 or each of both the warp yarn 11 and the weft yarn 12.

Further, a marking (not shown) for identification of the position of the sensor sections may be provided in such a manner that, for example, the fabric 13, the optical fiber 14, or the like is colored, or a symbol or the like is printed thereon. In this case, since the sensor sections can be securely attached to a measuring position of a measuring object, the accuracy of measurement can be further improved.

Further, a protective film may be applied by coating on the side of an outer surface of the sensor 10, thereby making it possible to more securely prevent the optical fiber 14 from being damaged, for example.

What is claimed is:

1. A reinforced sensor with an optical fiber woven into a fabric, comprising a fabric formed in a manner that a weft yarn is woven thereinto in a direction substantially perpendicular to a warp yarn, wherein an optical fiber is included in at least either one of fibers of the warp yarn and the weft yarn.

2. The reinforced sensor with an optical fiber woven into a fabric, according to claim 1, wherein the at least either one of fibers includes a high strength fiber higher in tensile strength than the optical fiber.

3. The reinforced sensor with an optical fiber woven into a fabric, according to claim 1, wherein the one of the fibers forms a fiber bundle including the optical fiber.

4. The reinforced sensor with an optical fiber woven into a fabric, according to claim 1, wherein the at least either one of the fibers includes a plurality of the optical fibers.

5. The reinforced sensor with an optical fiber woven into a fabric, according to claim 1, wherein the optical fiber functions as a FBG (Fiber Bragg Grating) sensor.

6. The reinforced sensor with an optical fiber woven into a fabric, according to claim 5, wherein a marking for identification of sensor sections of the optical fiber is provided.

7. The reinforced sensor with an optical fiber woven into a fabric, according to claim 1, wherein a protection film is provided on the side of an outer face.
